(19) United States
(12) Patent Application Publication
(10) Pub. No.: US 2006/0135005 A1
(43) Pub. Date: Jun. 22, 2006

(54) Snappy structural system

(76) Inventor: William August Gelonek, Redding, CA (US)

Correspondence Address: William Gelonek, 4540 Bechelli Lane, Redding, CA, 96002, US

(21) Appl. No.: 11/285,519

(22) Filed: Nov. 21, 2005

Related U.S. Application Data
(60) Provisional application No. 60/522,934, filed on Nov. 22, 2004.

(51) Int. Cl. H01R 13/73

(52) U.S. Cl. 439/894

(57) ABSTRACT

A modular structural system for vehicle and pedestrian bridges, buildings, etc. and more particularly a splice for interconnecting and providing a rigid connection between two sections of hollow tubing, as used in modular structures, wherein variability in span lengths is provided by means of alternate splice locations in the hollow tubing and variability of deck heights is provided by means of an adjusting system, each comprising a plurality of spring-pins (14a). The objectives and advantages of the internal safetied spring-pin splice are to provide an effective splice such that the forces imposed upon the hollow tubing from the splice connection are equalized and balanced across the cross-section of the hollow tubing and to provide a simply fabricated splice of minimum parts, thereby reducing manufacturing, assembly and erection costs as well as minimizing the probability of missing parts at the time of assembly.

### CROSS-REFERENCE TO RELATED APPLICATIONS

This application claims the benefit of provisional patent application Ser. No. 60/522,934, filed 2004 Nov. 22 by the present inventor.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to modular structural systems including bridges, buildings and other structural systems as a category and more particularly to splices and connections of hollow tubing as found in said bridges, buildings and other structural systems.

### BACKGROUND OF THE INVENTION—PRIOR ART

Modular bridge structures have been used for over 75 years as an economical, efficient, rapidly constructed means for carrying vehicles and pedestrians in both temporary and permanent applications. Such modular structures are also used in building construction and in other load carrying applications as well.

One of the earliest modular bridges began with the prior art Bailey Bridge, wherein members of the structure, that are repetitive and modular in nature, are connected by means of bolts and pins installed at the time the structure is assembled and erected at the site of its intended use.

Additional prior art is disclosed in U.S. Pat. No. 3,411,167 (Sedlacek); U.S. Pat. No. 4,520,523 (Fitzgerald-Smith et al); U.S. Pat. No. 4,665,830 (Anderson et al); U.S. Pat. No. 4,706,436 (Lattice Bridges).

U.S. Pat. No. 267,189 (Godman) discloses a modular bridge wherein successive chords of the bridge are spliced by inserting a block between respective chord members and fastening the chord members and block together with several bolts. The splice cannot be used in the bottom chord because the bottom chord is commonly under tensile forces, making the splice limited in its application.

A further prior art modular bridge is disclosed in U.S. Pat. No. 2,024,001 (Hamilton) wherein a plurality of u-shaped chord members is connected via corresponding plates overlying respective ends of the chord members and secured thereto via bolts. While effective, bolting requires special equipment and expertise to insure the bolts are properly tightened. Since this work is done at the site of assembly, expensive skilled labor is required to insure safety.

U.S. Pat. No. 384,196 (Duval) is a similar construction wherein a plurality of chords are placed in line with their ends abutting, plate iron jaws being riveted to the web of the chords such that the jaws of each bar enclose the web of the adjacent bar and are secured via pins inserted through both sets of jaws.

U.S. Pat. No. 320,079 (Martin) discloses a splice for beams or joists wherein each beam or joist is comprised of a central portion of timber and exterior rib of metal substantially but not entirely enclosing the upper surface of the timber. The splice consists of a pair of plates bolted or riveted to one end section internally of the plate but externally of the timber block and extending within the adjacent section and bolted or riveted thereto, thereby forming a sandwich splicing effect.

The U.S. patents of Godman and Duval have exposed plates, bolts and insert elements, subjecting all to corrosion and unsightly appearance. Additionally, if the bridge is to be disassembled and moved, as is often the case with modular bridges, corrosion causes significant difficulty during the disassembly process.

U.S. Pat. No. 4,965,903 (Bisch) discloses a splice for the side railings of modular bridges, said side railings being constructed of hollow tubing. The said splice comprises a plurality of ribs disposed within respective ends of adjacent ones of the side railings for defining respective slots there between, a plurality of plates adapted for insertion into the respective slots, and apparatus for securing the plurality of plates within the respective slots.

Modular bridges are plagued with the burden of having a profusion of parts, as is the case with the U.S. patent of Bisch. Plates and bolts are prone to get lost and misplaced, making it difficult if not impossible to complete the assembly and erection of a bridge. The entire prior art requires highly skilled and expensive labor to assemble and erect the inventions.

### BACKGROUND OF THE INVENTION—OBJECTS AND ADVANTAGES

According to an aspect of the present invention, a modular structural system is provided, comprising a plurality of side railings configured with a plurality of hollow tubing and adapted for modular interconnection in parallel rows. Said side railings are spliced together via a plurality of internal, safetied spring-pins.

The objectives and advantages of the internal safetied spring-pin splice are:
(a) to provide an effective splice such that the forces imposed upon the hollow tubing from the splice connection ate equalized and balanced across the cross-section of the hollow tubing.
(b) to provide a simple splice of minimum parts thereby reducing manufacturing and assembly costs, and minimizing the probability of missing parts at the time of assembly.
(c) to provide a splice where parts are not lost or misplaced during transport and storage, because the connecting components are not separate parts, rather are internal and secure.
(d) to provide a splice where the procedure for assembly is uncomplicated and intuitive, requiring a minimum of expertise and specialized tools.
(e) to provide a splice where time of field assembly is at a minimum, to reduce the cost of field crews and time to complete the assembly and erection process.

According to another aspect of the invention, a modular bridge is provided, constructed from a plurality of hollow tubing, and unlike any prior art, at the time of assembly, variability is provided in selecting span lengths, utilizing the same components. This is accomplished by providing an alternate splice point at each connection. Such an allowance has a significant effect in the potential range of span possibilities utilizing the same inventory of parts.

The possible span configurations are illustrated by the following: If, at the time of manufacture, alternate splice points are provided one foot apart, then, utilizing nine-10 foot long side railings and one-5 foot side railing, spans can range from 50 through 105 feet at one foot intervals. This advantage makes it possible to stockpile the said components and be prepared for a very wide range of needs, particularly during flood losses or road detour requirements. Other components of the bridge are configured to allow for the variation in span.

According to another aspect of the invention, a modular bridge is provided, constructed from hollow tubing, and unlike any prior art, deck height adjustability is provided by means of deck-height adjustment tubes which are spring-pin connected to vertical truss members. This advantage makes it possible to meet existing roadway grade conditions of a washed out bridge, for example.

### SUMMARY

In accordance with the present invention a modular structural system, and more particularly a splice for interconnecting and providing a rigid connection between two sections of hollow tubing, as found in modular bridges, wherein variability in span lengths is provided by means of alternate splice locations in the hollow tubing and variability of deck heights is provided by means of an adjusting system, each comprising a plurality of spring-pins.

### DRAWINGS—FIGURES

FIG. 1 shows a partial side elevation of a modular bridge

FIG. 2 shows a partial plan view of a modular bridge

FIG. 3 is a cross section of a spring-pin taken along lines 3-3 of FIG. 1

FIG. 4 is an exploded perspective view of the detail area 4 in FIG. 1

FIG. 5 is an exploded perspective view of the method of connection of two adjacent hollow tubes and a floor beam

FIG. 6 is an elevation view of an extended floor beam support member connected to two deck height adjustment tubes

FIG. 7 is an elevation view of a floor beam support member connected to two deck height adjustment tubes

FIG. 8 is a cross section view taken along lines 8-8 of FIG. 7

FIG. 9 is a side elevation view of a deck height adjustment tube

FIG. 10 is an end elevation view of a deck height adjustment tube

FIG. 11 is a cross section view taken along lines 11-11 of FIG. 9

### DRAWINGS—REFERENCE NUMERALS

6 modular side railing

8 vertical member

10 diagonal member

12 chord member

14a spring-pin

14b hole for penetration of spring-pin

16 floor beam

18 T-plate

20 corrugated metal deck

22 open grating deck

24 deck height adjustment tube

26 floor beam support member

28 extended floor beam support member

30 stringer

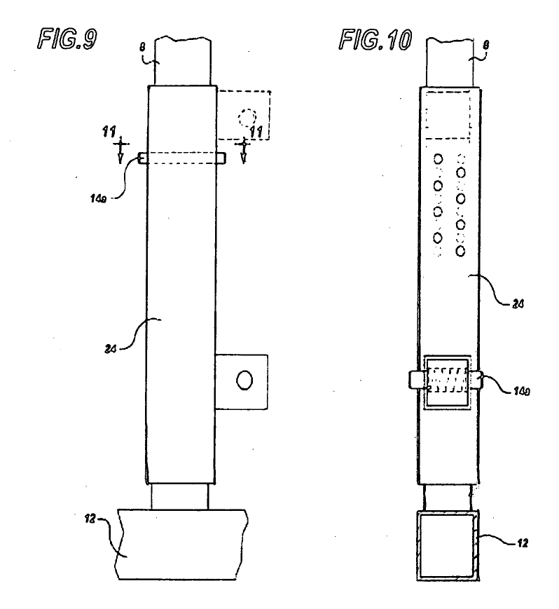

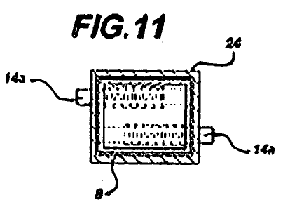

### DETAILED DESCRIPTION—FIGS 1 TO 11

A preferred embodiment of the invention is illustrated in FIGS. 1 through 11. FIG. 1 shows a plurality of connected modular side railings 6. Side railings 6 are typically ten feet in length though can be of different lengths depending upon the intended application.

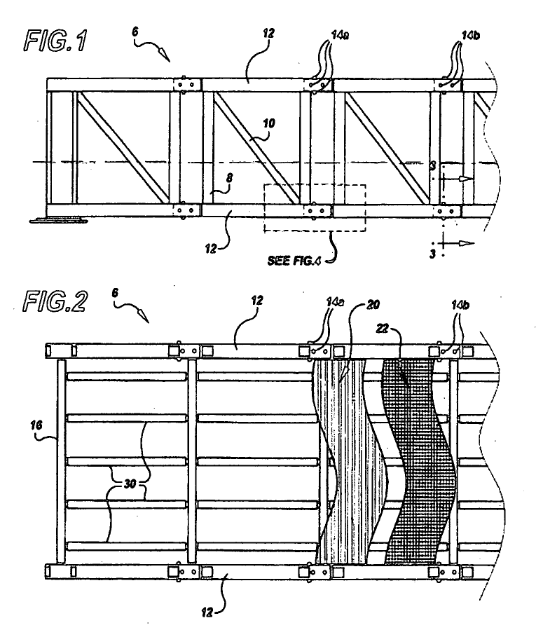

FIG. 2 shows assembly of a plurality of two parallel side railings 6, along with floor beams 16, stringers 30 and decks 20, 22. All of the field assembly is connected with spring-pins 14a.

Floor beam 16, is a member positioned perpendicular to the side railings 6. Its function is to provide the primary support for the stringers 30.

Stringer 30 is a structural member, spanning between floor beams 16. Stringers 30 have two (2) holes at each end through which spring-pins 14a, contained in stringer stubs (not shown), can penetrate for a secure connection. Stringer stubs are hollow sections and are welded to the web of the floor beams 16. The stringers 30 serve as the primary support for the deck.

Decks 20, 22 are a platform shaped configuration of members that supports the roadway surfacing. The deck 20 is constructed of corrugated metal upon which a running surface is placed. The deck 22 is constructed as an open grating. Running surfaces for the corrugated metal deck 20 include asphalt, concrete and timber. Other possible configurations for a deck include orthotropic steel, steel/elastomer/steel and fiberglass reinforced plastic. The decks 20, 22 are supported on the stringers 30 and are fabricated and connected to the stringers 30 by welding (preferred), bolting and clamping, or otherwise fastened. The decks 20, 22 are entirely connected to the stringers 30 prior to field or site assembly or erection of the primary structural members. The advantage is that the placement and field attachment of the decks 20, 22 is a simple matter of lifting the decks 20, 22/stringer 30 fabrications and placing it on the stringer stubs to complete the spring-pin 14a connection.

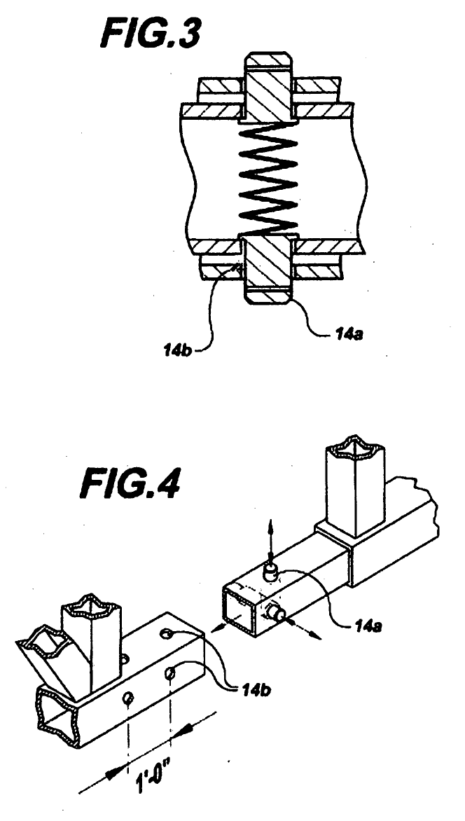

FIG. 3 is a cross sectional view of a spring-pin assembly 14a, showing two pins and a partially compressed spring. The spring-pin assembly 14a is made up of two (2) standard structural pins, with heads, and one low-constant spring, all housed in a greased PVC pipe. The grease serves as lubrication and protection against corrosion. The spring-pin 14a serves multiple purposes including connecting primary and secondary structural components. Primary components include side railings 6, floor beams 16, and stringers 30. Secondary components include bracing. Additionally, spring-pins 14a are used for connecting multiple side railings (side by side and above/below). The view shows two spring-pins 14a positioned and seated, in an extended position, through two hollow tubes. Retaining rings (not shown) placed in the grooves of the spring-pins 14a safety the spring-pins 14a in position.

Typically the side railing has top and bottom members called chords 12(either of the two outside members of the truss), often parallel to one another though not always. Between the chords are vertical 8 and diagonal 10 members. The component parts of the side railings 6 are joined and shaped by welding (preferred), bolting, pinning, bending and otherwise fastening the members to form the side railing 6.

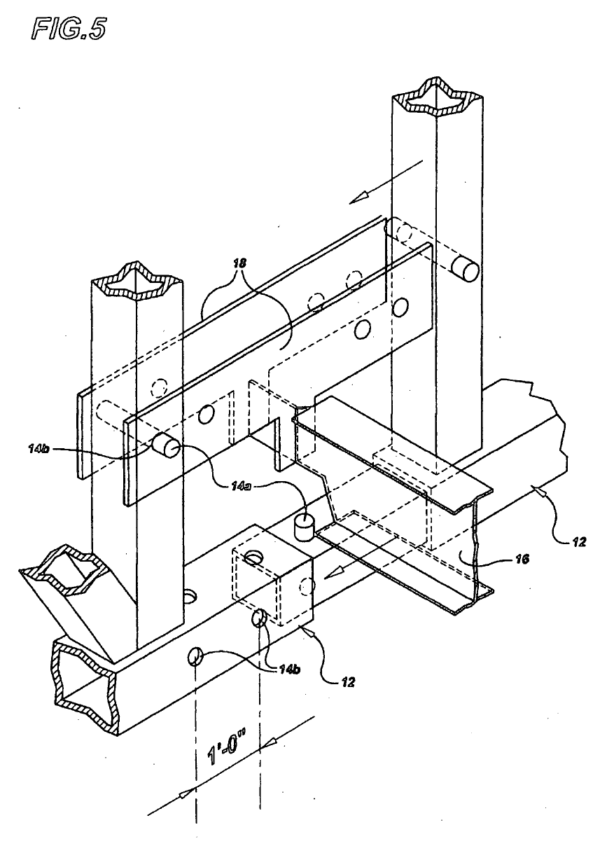

FIG. 4 is an exploded perspective view of the detail area 4 in FIG. 1. The view shows four spring-pins 14a in an extended position, prior to being connected to another chord 12.

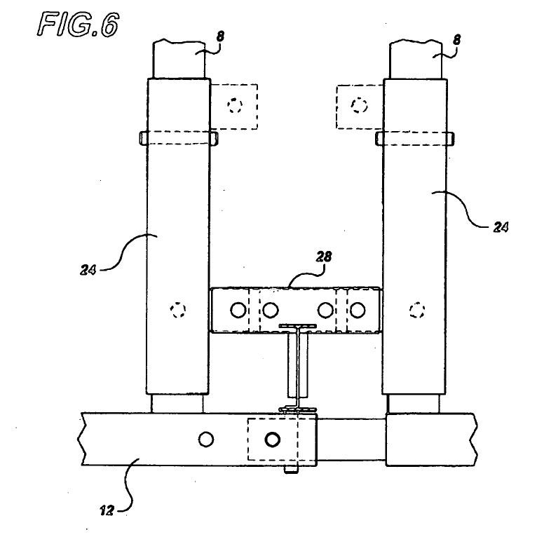

FIG. 5 is an exploded perspective view of the method of connection of two adjacent chords 12 and a floor beam 16. The preferred method of assembly is to first connect the plurality of side railings 6. As can be seen in FIG. 5, one side railing 6 is moved to a mating position with another adjacent side railing 6. The spring-pins 14a are manually shortened by pressing on the spring-pins 14a until they clear the adjacent chord 12. After two completed sets of side railings 6 are connected, they are positioned at a distance apart based on design requirements of the structure, typically parallel to one another. In the case of a bridge structure, the positioning of the side railings 6 can be either on the abutments or other supports of the structure or on the ground close to the final position of the side railings 6. The floor beams 16, which are welded to T-plates 18, are next lifted in position to be connected to the side railings 6. By rotating the floor beams 16, around their long axis, through an angle of 90 degrees, the T-plates 18 are easily passed between the vertical members 8 on both side railings 6. The floor beams 16 are then counter-rotated, around their long axis, through an angle of 90 degrees to line up the holes 14b with the spring-pins 14a contained in the vertical members 8.

The two assembly procedures, side railings 6 and floor beams 16 are considerably simpler and hence less expensive to perform than the prior art. There are no loose plates, bolts, washers and nuts to get lost or confused as to where they belong. There are no special tools or special skill required in the assembly, reducing cost. The process is entirely intuitive.

Connecting the floor beams 16 to the vertical members 8 provides increased stiffness over connections of floor beams at or near the bottom chord. There is increased lateral stability to the assembled structure, limiting lateral deflection under load.

FIG. 6 is an elevation view of an extended floor beam support member 28 connected to two deck height adjustment tubes 24. The deck height adjustment tubes 24 are positioned at the required vertical position, being held in position by spring-pins 14a. The connection of the floor beams 16 is the same as described before.

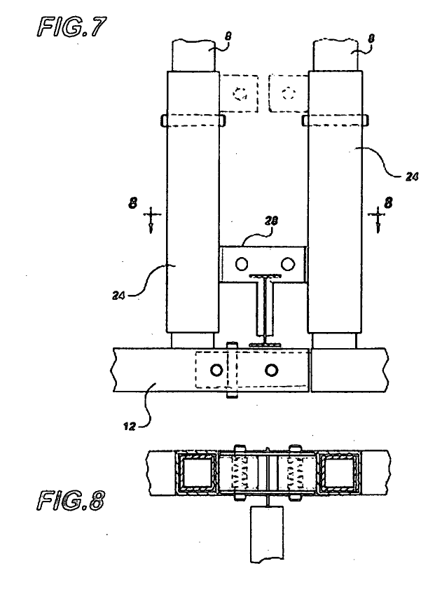

FIGS. 7 through 11 show additional views of the deck height adjustment system.

The preference is for side railings 6, spring-pins 14a, floor beams 16, stringers 30, deck height adjustment tubes 24, T-plates 18, floor beam support members 26, extended floor beam support members 28 and related hardware to be all metallic. Galvanized steel is preferred for decks 20,22.

Other embodiments and variations of the present invention are contemplated. The plurality of spring-pins 14a can be applied to other structures using hollow shapes including metallic, fiberglass reinforced plastic, wood and aluminum. To that end the inventive splice could be used in a wide variety of applications including buildings, falsework used to support construction components and materials, towers, cranes and bridge substructures.

Additionally, whereas the preferred embodiment discloses a splice for application with square tubing, it is contemplated that the spring-pin 14a is equally applicable to hollow tubing having rectangular, circular or other cross section.

All such embodiments or variations are believed to be within the scope of the present invention as defined by the claims appended hereto.

I claim:

1. A splice for connecting and providing a rigid connection between two sections of hollow tubing, comprising a plurality of spring-pins.

2. A splice as defined in claim 1 wherein variability in span lengths is provided by means of alternate splice locations between sections of said two sections of hollow tubing.

3. A splice as defined in claim 1 wherein said means for connecting further comprises:
a) at least two holes extending through each of said two sections of the said hollow tubing.

4. A splice as defined in claim 1 where the quantity and dimensions of each said plurality of spring-pins are dependent upon the size of the connected sections of hollow tubing.

5. A splice as defined in claim 3 where each said hole is approximately ⅛ inch larger than the diameter of the spring-pin associated with it.

6. A deck height adjusting system comprising:
a) a first a plurality of deck height adjustment tubes sized to fit concentrically around a plurality of vertical members of a side railing for providing connection of said deck to said plurality of said vertical members of a side railing and providing a means for raising or lowering the height of said deck.
b) a second a plurality of extended floor beam support members for connecting said deck to said deck height adjustment tubes.

7. Deck height adjustment system as defined in claim 6 wherein said means for adjusting the height of said deck comprises a plurality of spring-pins and a means for securing said spring-pins for providing a rigid connection between said plurality of deck height adjustment tubes and said vertical members of a side railing wherein said means for securing further comprises:
a) at least two holes extending through one end of each said plurality of deck height adjustment tubes and at least two holes extending through each said vertical member of a side railing.

8. Deck height adjustment system as defined in claim 6 wherein a plurality of spring-pins serves to connect said extended floor beam support members and said plurality of deck height adjustment tubes wherein said means for securing further comprises:
a) a first a deck height adjustment system as defined in claim 7 wherein the dimensions of each said plurality of spring-pins are dependent upon the size of the connected sections.
b) a second a deck height adjustment system as defined in claim 7 where each said hole is approximately ⅛ inch larger in diameter than the associated spring-pin.

9. A modular structural system comprising:
a) two end-side railings for connection to supports
b) a plurality of interior-side railings wherein adjacent panels are connected with splices to each other and said end-side railings by means at a plurality of spring-pins.
c) a plurality of extended floor beam support members welded to each end of a plurality of floor beams, connected to a plurality of deck height adjustment tubs, by means of a plurality of spring-pins.
